(19) United States
(12) Patent Application Publication
(10) Pub. No.: US 2026/0245494 A1
(43) Pub. Date: Aug. 20, 2026

(54) DISPLAY WITH CLUSTER-CONTROLLED COLOR QUANTIZATION

(71) Applicants: Imre Knausz, Fairport, NY (US); Ronald S. Cok, Rochester, NY (US); Joseph Wan, Cary, NC (US)

(72) Inventors: Imre Knausz, Fairport, NY (US); Ronald S. Cok, Rochester, NY (US); Joseph Wan, Cary, NC (US)

(21) Appl. No.: 19/543,211

(22) Filed: Feb. 18, 2026

Related U.S. Application Data
(60) Provisional application No. 63/759,588, filed on Feb. 18, 2025.

(51) Int. Cl. G09G 3/20; G09G 3/32

(52) U.S. Cl. CPC G09G 3/2096; G09G 3/32; G09G 2320/0242; G09G 2320/0666; G09G 2340/14; G09G 2360/04; G09G 2360/16

(57) ABSTRACT

A color display can have an array of display pixels controlled by a cluster controller in mutually exclusive display clusters that emit light of different colors responsive to a display-pixel value and pixel color. A display controller can calculate a color palette of different pixel colors for each display cluster derived exclusively from pixel colors of mutually exclusive image clusters of image pixels in a digital image, and can transmit the color palette to the cluster controller with a display-pixel value for each display pixel referencing a pixel color in the color palette. Each cluster controller can control each display pixel in the display cluster to emit light responsive to the pixel color in the color palette referenced by the display-pixel value. For each display cluster, a number of pixel colors in the color palette is smaller than a number of display pixels in the display cluster.

### CROSS-REFERENCE TO RELATED APPLICATION

This patent application claims the benefit of U.S. Provisional Patent Application No. 63/759,588, filed Feb. 18, 2025, which is incorporated by reference herein in its entirety.

### TECHNICAL FIELD

The present disclosure relates generally to devices, structure, and methods for micro-transfer-printed displays using color-quantized images.

### BACKGROUND

Color displays are widely used to present images and information in graphic user interfaces controlled by computers. Such displays incorporate an array of light-controlling pixels. Each pixel emits or otherwise controls light. For example, liquid crystal displays control light emitted from a back light with a light-blocking liquid crystal at each pixel, organic light-emitting displays emit light from a stack of organic films, and inorganic light-emitting displays emit light from semiconductor crystals.

Historically, because the graphic circuits used to control displays were very limited, for example in size, complexity, and throughput, the displays could show only a few different colors, for example 256 colors. More recently, with improved circuits displays can show many more colors, for example 16 million or more colors. However, for displays with many color pixels (for example high definition, 4 k, or 8 k displays), the amount of data necessary to specify the color of each pixel at a desired image frame rate is very large and can require a large bandwidth to communicate the data to the display, necessitating expensive display control circuits or limiting some combination of the number of display colors, number of display pixels, or display frame rate.

There is a need, therefore, for improvements in devices, circuits, and methods for displays.

### SUMMARY

The present disclosure provides, inter alia, architectures, structures, systems, devices, and methods for improved image displays.

According to embodiments of the present disclosure, a color display can comprise an array of display pixels comprising mutually exclusive display clusters of display pixels. Each display pixel can be operable to emit light of different colors responsive to a display-pixel value and pixel color. A cluster controller can be operable to control the display pixels in each display cluster of display pixels to emit light of different colors. A display controller can be operable to (i) calculate a color palette of different pixel colors for each display cluster derived exclusively from pixel colors of mutually exclusive image clusters of image pixels in a digital image, each image pixel corresponding to a display pixel, and (ii) transmit the color palette to the cluster controller with a display-pixel value for each display pixel in the display cluster referencing a pixel color in the color palette. Each cluster controller can be operable to (i) receive the color palette and display-pixel values from the display controller and (ii) control each display pixel in the display cluster to emit light responsive to the pixel color in the color palette referenced by the display-pixel value. For each display cluster, a number of pixel colors in the color palette can be smaller than a number of display pixels in the display cluster. Thus, pixel colors in the color palette can represent one or more pixel colors in an image cluster with the display cluster, rather than reproduce all of the pixel colors in the image cluster, for example when the color palette has fewer colors than are present in the image cluster.

In some embodiments, each display cluster comprises display pixels that are locally adjacent. In some embodiments, each image cluster can comprise image pixels that are locally adjacent. In embodiments, the display-pixel value has a number of bits equal to log2 of the number of colors in the color palette. In some embodiments, one-or-more pixel colors in the color palette of a display cluster are pixel color(s) of one or more of the image pixels corresponding to display pixels in the display cluster. In some embodiments, one-or-more pixel colors in the color palette of a display cluster are not pixel color(s) of one or more of the image pixels corresponding to display pixels in the display cluster. In some embodiments, one or more colors in the color palette of a display cluster are a combination of colors of two or more of the image pixels corresponding to display pixels in the display cluster. In some embodiments, each display-pixel value in a display cluster can reference a pixel color in the color palette that is closest to a pixel color of an image pixel corresponding to the display pixel in the display cluster.

According to embodiments of the present disclosure, the color display can have a display area including the display pixels and the cluster controller of one or more display clusters can be disposed within the display area, between two or more display pixels in the display area, or both.

According to embodiments of the present disclosure, the cluster controller can be connected to each display pixel in the display cluster and can provide passive-matrix or active-matrix control to the display pixels.

In some embodiments, the cluster controller can be a micro-transfer-printed integrated circuit comprising a fractured (e.g., broken) or separated tether.

In some embodiments, each display pixel can comprise two-or-more light emitters that emit different colors of light. In embodiments, the two-or-more light emitters can be micro-transfer-printed micro-light-emitting diodes comprising a fractured or separated tether.

According to embodiments of the present disclosure, each cluster controller can comprise one-or-more of (i) a color-palette memory operable to store the color palette, (ii) a display-pixel-value memory operable to store display-pixel values, and (iii) a display-pixel-color memory operable to store pixel colors. In some embodiments, the cluster controller can be operable to add received error-correcting pixel colors to stored pixel colors to combine the pixel colors and the error-correcting pixel colors. In some embodiments, the cluster controller can be operable to add received pixel colors to stored zero values.

In some embodiments, the color palette for one display cluster can be different from a color palette in at least one different display cluster. In some embodiments, the display controller can be operable to send the same color palette to multiple cluster controllers.

In embodiments, an image cluster can include an image number of image pixels, a display cluster can include a display number of display pixels equal to the image number, and the display pixels can correspond to the image pixels, for example corresponding image and display pixels can have common or the same relative positions within the image cluster (e.g., image pixel location within the image cluster) and the display cluster (e.g., display pixel location within the display cluster).

According to some embodiments of the present disclosure, an image cluster can include an image number of image pixels and a display cluster can include a display number of display pixels less than the image number, and the display pixels can correspond to a subset of the image pixels. The image number can be a positive integer number times the display number. In some embodiments, at least one image cluster can correspond to multiple display clusters, so that the image pixels of the at least one image cluster can correspond to the display pixels of multiple display clusters.

According to some embodiments of the present disclosure, the display controller can be operable to calculate a pixel-color error for each image cluster responsive to image pixels in the image cluster and corresponding pixel colors in the color palette referenced by the display-pixel values. In some embodiments, the display controller can be operable to compare the pixel-color error for each image cluster to a color-error threshold and, if the pixel-color error is greater than or equal to the color-error threshold, (i) transmit image pixels to the corresponding display cluster and the cluster controller can be operable to receive and display the image pixels or (ii) select a larger color palette with corresponding pixel colors and transmit the pixel colors of the larger color palette to the corresponding display cluster and the cluster controller can be operable to receive and display the pixel colors of the larger color palette.

According to some embodiments of the present disclosure, a method of operating a color display comprising display clusters of mutually exclusive color display pixels can comprise (i) receiving a digital image comprising image pixels with a display controller, each image pixel defining a pixel color associated with a corresponding display pixel, (ii) using the display controller, calculating a color palette for each display cluster derived exclusively from image pixels in the image corresponding to display pixels in the display cluster, the color palette having fewer colors than display pixels in the display cluster, (iii) using the display controller, transmitting (i) the color palette and (ii) a display-pixel value that references one of the colors in the color palette for each display pixel in the display cluster to the cluster controller of the display cluster, (iv) using each cluster controller of a display cluster, receiving a color palette and a display-pixel value referencing one of the colors in the color palette for each display pixel in the display cluster from the display controller, and (v) responsive to the color palette and the reference, emitting light from each display pixel in the display cluster with display pixels under the control of the cluster controller.

In some embodiments, the display-pixel values can be first display-pixel values and methods can further comprise (i) with the display controller, transmitting a second display-pixel value referencing one of the colors in the color palette for each display pixel in the display cluster to the display cluster, wherein the second display-pixel value is a difference between the corresponding image pixel and the first display-pixel value, (ii) with each cluster controller of a display cluster, receiving a second display-pixel value for each display pixel in the display cluster, and adding the color palette color referenced by the second display-pixel value to the color palette color referenced by the first display-pixel value to specify a corrected color, (iii) and with each display pixel in the display cluster, emitting light corresponding to the corrected color under the control of the cluster controller. In some embodiments, the display controller can calculate a pixel-color error for each image cluster responsive to image pixels in the image cluster and corresponding pixel colors in the color palette referenced by the display-pixel values. In some embodiments, the display controller can be operable to compare the pixel-color error for each image cluster to a color-error threshold and, if the pixel-color error is greater than or equal to the color-error threshold, (i) can transmit image pixels to the corresponding display cluster and the cluster controller can be operable to receive and display the image pixels or (ii) can select a larger color palette and transmits the pixel colors of the larger color palette to the corresponding display cluster and the cluster controller can be operable to receive and display the pixel colors of the larger color palette.

According to embodiments of the present disclosure, a color-display cluster can comprise an array of display pixels, each display pixel operable to emit light of different colors responsive to a display-pixel value and pixel color, a color palette comprising different pixel colors derived exclusively from pixel colors of mutually exclusive image clusters of image pixels in a digital image corresponding to the display pixels, a cluster controller can be operable to (i) control the display pixels to emit light of different pixel colors, (ii) receive a color palette and display-pixel values, and (iii) control each display pixel to emit light specified by the pixel color in the color palette referenced by the display-pixel value. The display-pixel value for each display pixel can reference a pixel color in the color palette. For each display cluster, a number of pixel colors in the color palette can be smaller than a number of display pixels in the display cluster.

Embodiments of the present disclosure provide displays with improvements in the number of colors, number of pixels, image frame rates, and cost.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a schematic diagram of a display comprising display clusters according to illustrative embodiments of the present disclosure;

FIG. 2A is a schematic diagram of a cluster controller for display clusters according to illustrative embodiments of the present disclosure;

FIG. 2B is a schematic diagram of a display cluster with a cluster controller of FIG. 2A according to illustrative embodiments of the present disclosure;

FIG. 3 is a schematic diagram of image pixel clusters in a digital image and corresponding display pixel clusters in a color display according to illustrative embodiments of the present disclosure;

FIG. 4 is a schematic diagram of image pixel clusters in a digital image and corresponding display pixel clusters in a color display having fewer display pixels than image pixels in the image pixel clusters according to illustrative embodiments of the present disclosure;

FIG. 5 lists three tables of display-pixel values referencing color palettes according to illustrative embodiments of the present disclosure;

FIG. 6 is a flow diagram of operating methods using cluster color quantization according to illustrative embodiments of the present disclosure;

FIG. 7 is a flow diagram of operating methods using cluster color error correction according to illustrative embodiments of the present disclosure;

FIG. 8 is a flow diagram of operating methods using cluster color error correction according to illustrative embodiments of the present disclosure;

FIG. 9 comprises five tables of image pixels, quantized display pixels, color pixel errors, color palettes, and display-pixel values according to illustrative embodiments of the present disclosure;

FIG. 10 is a flow diagram of operating methods using image values according to illustrative embodiments of the present disclosure; and

FIG. 11 is a flow diagram of operating methods using increased color-palette size according to illustrative embodiments of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The figures are not necessarily drawn to scale.

### DETAILED DESCRIPTION OF CERTAIN EMBODIMENTS

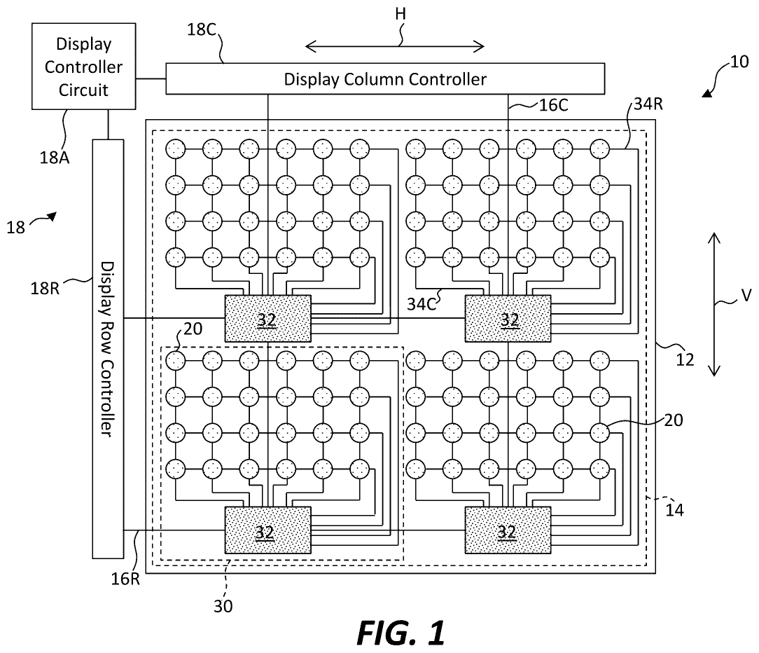

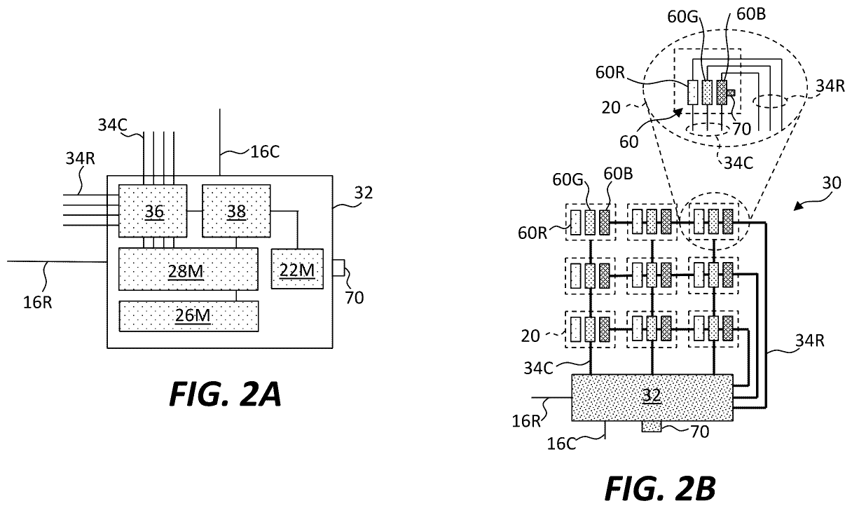

According to embodiments of the present disclosure and as shown in FIGS. 1, 2A, 2B, 3, 4, and 5, among other things, a color display 10 can comprise an array of display pixels 20 comprising mutually exclusive display clusters 30 of display pixels 20 (e.g., display-pixel clusters 30) as shown in FIG. 1. Each display pixel 20 is contained within only one display cluster 30 and can be operable to emit light of different colors responsive to a display-pixel value 22 referencing a pixel color 24 (see FIGS. 2A, 2B) in a color palette 26 stored in display cluster 30, e.g., in a cluster controller 32 of each display cluster 30. Each display-pixel value 22 in a display cluster 30 can correspond to a display pixel 20 in display cluster 30 and can associate a pixel color 24 in a color palette 26 for each display cluster 30 with the corresponding display pixel 20.

A color palette 26 comprises multiple different pixel colors 24 associated with an image cluster 48 of image pixels 42 each corresponding to a display pixel 20 in a corresponding display cluster 30. A cluster controller 32 can be operable to control display pixels 20 in each display cluster 30 of display pixels 20 to emit light of different colors, e.g., pixel colors 24. Display pixels 20 and cluster controllers 32 can be disposed in a display area 14 on or over a display substrate 12. Because a color palette 26 can have fewer pixel colors 24 than image pixels 42 in an image cluster 48, corresponding pixel colors 24 of display pixels 20 of display clusters 30 can represent (e.g., approximate) but not exactly reproduce all pixel colors 24 of image pixels 42 in image cluster 48, unless the number of pixel colors 24 in image cluster 48 is the same or less than the number of pixel colors 24 in color palette 26, so that the displayed image has fewer different pixel colors 24 than the digital image 40, e.g., has color contouring.

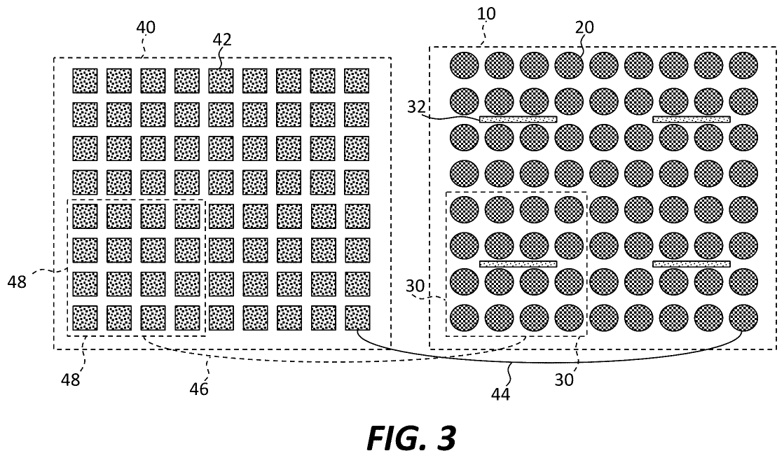

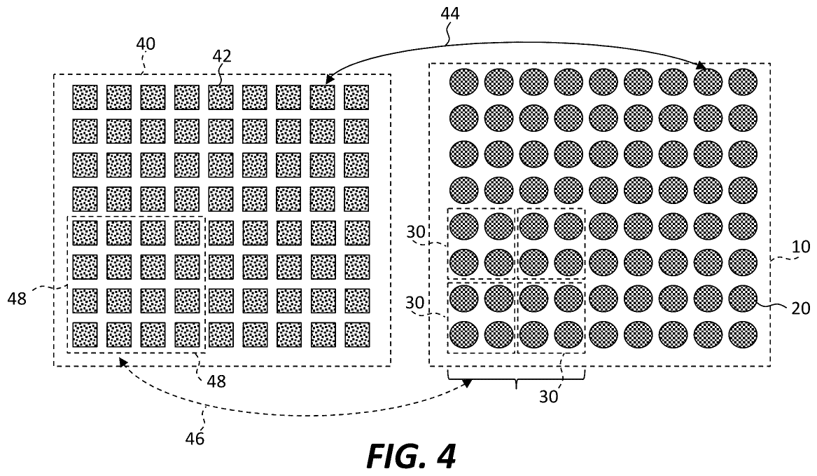

Display pixels 20 can be disposed regularly and uniformly in display area 14 separated by a same horizontal-separation distance in a horizontal (X) direction H and a same vertical-separation distance in a vertical (Y) direction V with cluster controllers 32 disposed between display pixels 20 in color display 10 (shown non-uniformly in FIG. 1 but shown uniformly in FIGS. 3 and 4), for example by micro-transfer printing micro-devices, for example micro-transfer-printing micro-inorganic-light-emitting diodes (iLED) 60 and one-or-more integrated circuit(s) comprising cluster controllers 32 non-native to display substrate 12 on to display substrate 12 in display area 14 so that the micro-devices are transferred from a different source wafer or source substrate than display substrate 12 to display substate 12. In consequence of micro-transfer printing, the micro-devices can comprise fractured or separated tethers 70 (shown in FIGS. 2A, 2B for cluster controller 32 and one iLED 60).

Display pixels 20 in a display cluster 30 can be connected (e.g., electrically connected in a matrix or array) to cluster controller 32, for example with cluster row wires 34R for rows of display pixels 20 in display cluster 30 and cluster column wires 34C for columns of display pixels 20 in display cluster 30. Display pixels 20 can be connected to and controlled by cluster controller 32 using active-or passive-matrix control, for example using row-select signals and column-data signals on cluster row wires 34R and cluster column wires 34C, respectively. Similarly, cluster controllers 32 (and display clusters 30) can be arranged and connected (e.g., electrically) in a matrix or array on display substrate 12 in display area 14 and can be connected to and controlled by display controller 18 using active-or passive-matrix control.

Display controller 18 of color display 10 can control cluster controller 32 of each display cluster 30 by sending control signals (e.g., cluster row-select signals and cluster column-data signals) to cluster controllers 32, for example with a display row controller 18R and a display column controller 18C controlled by display control circuit 18A, over display row wires 16R and display column wires 16C. Display control circuit 18A, display row controller 18R, and display column controller 18C can comprise a display controller 18. Display controller 18 can provide active-or passive-matrix control to cluster controllers 32.

As shown in FIG. 2A, cluster controller 32 can comprise a cluster control circuit 38 responsive to control signals from display controller 18 provided on display row and display column wires 16R and 16C to store and process data (e.g., pixel colors 24 in a color palette 26 and display-pixel values 22) received from display controller 18. Pixel colors 24 can be stored as a color palette 26 in color-palette memory 26M and display-pixel values 22 can be stored in display-pixel-value memory 22M. Cluster control circuit 38 can be operable to access a pixel color 24 in color palette 26 stored in color-palette memory 26M referenced by a display-pixel value 22 stored in display-pixel-value memory 22M and store the referenced pixel color 24 in a display-pixel-color memory 28M at memory locations corresponding to display pixels 20. In some embodiments, pixel colors 24 of color palette 26 or display-pixel values 22 are not separately stored but are used by cluster control circuit 38 to store pixel colors 24 in display-pixel-color memory 28M locations corresponding to display-pixel values 22. Each display-pixel value 22 therefore can correspond to a display pixel 20 and reference a pixel color 24 in color palette 26 specifying the color and luminance of light emitted from corresponding display pixel 20 stored at a location in display-pixel-color memory 28M corresponding to display pixel 20.

Display-pixel-color memory 28M can store a pixel color 24 for each light controller (e.g., light emitter) 60 in each display pixel 20 of display cluster 30. Cluster control circuit 38 can also be operable to modify pixel colors 24 stored in display-pixel-color memory 28M, for example in response to control or error signals from display controller 18. Under the control of cluster control circuit 38, drivers 36 of cluster controller 32 can access or respond to pixel colors 24 stored in display-pixel-color memory 28M to drive (e.g., at a desired current and voltage) each light controller 60 of each display pixel 20 in display cluster 30 to emit light corresponding to pixel color 24 associated with each light controller 60 of display pixel 20, for example using cluster row and column wires 34R, 34C.

FIG. 2B illustrates a display cluster 30 comprising cluster controller 32 connected to display pixels 20 with cluster row and column wires 34R, 34C, for example in an array or matrix. Each display pixel 20 can comprise two-or-more light controllers 60, for example two, three, four, or five inorganic micro-light-emitting diodes (iLEDs) 60 that each emit different colors of light when provided with suitable electrical power for a desired period of time, such as an image frame (frame period or frame time) in an image sequence such as a video sequence. In embodiments, each display pixel 20 can comprise a red iLED 60R operable to emit red light, a green iLED 60G operable to emit green light, and a blue iLED 60B operable to emit blue light. iLEDs 60 and cluster controller 32 can be micro-transfer printed to display substrate 12 and can comprise a fractured or separated tether 70. Such micro-transfer printed devices (e.g., cluster controller 32 and iLEDs 60 can be bare, unpackaged semiconductor devices having a small form factor, for example having a thickness no greater than one hundred, fifty, twenty, ten, or five microns and a length or width (or both) no greater than two hundred, one hundred, fifty, twenty, ten, or five microns, thus enabling a high-resolution color display 10 with cluster controller 32 integrated and disposed in display area 14 of color display 10.

Display controller 18 and cluster controllers 32 can be integrated circuits constructed and connected using photolithographic materials and methods known in the art, for example silicon or CMOS circuits. Color-palette memory 26M, display-pixel-value memory 22M, and display-pixel-color memory 28M can be memories (e.g., static or dynamic random-access memories), registers, flip-flops, or other electronic devices for storing binary digital data (bits). In some embodiments, display-pixel-color memory 28M can comprise a shift register, e.g., a recirculating serial shift register or a parallel shift register, suitable for storing pixel colors 24 corresponding to each display pixel 20 and providing the stored pixel colors 24 to driver 36, for example bit-wise serially or bit-wise in parallel. Pixel colors 24 can specify a value for each light controller 60 in each display pixel 20 in display cluster 30 stored at a desired input image frame rate and can provide the value to each light controller 60 under the control of cluster control circuit 38 at a desired output image frame rate (that can be the same as or different from the input image frame rate).

Display substrate 12 can be any suitable substrate, for example display substrates 12 such as glass, plastic, or resin. Wires (e.g., display row and column wires 16R, 16C and cluster row and column wires 34R, 34C) can be disposed on display substrate 12 using materials and methods known in the display arts, for example using metals (e.g., such as aluminum or copper) deposited, for example using evaporation, sputtering, or electro-deposition, and patterned using lithography.

FIG. 3 illustrates a digital image 40 comprising an array of image pixels 42. Each image pixel 42 can specify a pixel color 24, for example defining the information stored in or by digital image 40. FIG. 3 also illustrates a color display 10 comprising an array of display pixels 20. Each image pixel 42 can correspond to or be associated with a display pixel 20 that emits light corresponding to the pixel color 24 of image pixel 42 to display digital image 40. An image pixel 42 corresponding to a display pixel 20 is indicated with a line 44 illustrating corresponding image pixels 42 and display pixels 20 in FIG. 3. Corresponding image pixels 42 and display pixels 20 typically have same relative locations in the array of image pixels 42 in digital image 40 as in the array of display pixels 20 of color display 10. Similarly, image pixels 42 in an image cluster 48 can have a same relative location as display pixels 20 in a display cluster 30 corresponding to image cluster 48. Image clusters 48 can have a same relative location in digital image 40 as corresponding display clusters 30 in color display 10.

Digital image 40 can comprise image clusters 48 of image pixels 42 and the array of display pixels 20 in color display 10 can comprise display clusters 30. Each display cluster 30 can comprise display pixels 20 that are locally adjacent (e.g., are nearest neighbors such that no other display pixel 20 that is not in display cluster 30 is between display pixels 20 that are in display cluster 30). Each image cluster 48 can comprise image pixels 42 that are locally adjacent (e.g., are nearest neighbors such that no other image pixel 42 that is not in image cluster 48 is between image pixels 42 that are in image cluster 48). In some embodiments and as shown in FIG. 3, each image cluster 48 can correspond to a display cluster 30 (as shown with the line 46 in FIG. 3 illustrating corresponding image and display clusters 48, 30 each having a four-by-four array of image and display pixels 42, 20, respectively) so that the number of image pixels 42 in an image cluster 48 is the same as a number of display pixels 20 in a display cluster 30. As with corresponding display and image pixels 20, 42, display and image clusters 30, 48 can have a same relative position in an array of display clusters 30 and image clusters 48 of color display 10 and digital image 40, respectively.

In some embodiments and as illustrated in FIG. 4, image clusters 48 have more image pixels 42 than display clusters 30 have display pixels 20 so that multiple display clusters 30 correspond to a single image cluster 48. As shown in FIG. 4, image clusters 48 can comprise a four-by-four array of image pixels 42 that corresponds to a two-by-two array of display clusters 30, each of the display clusters 30 comprising a two-by-two array of display pixels 20. The size of image clusters 48 and display clusters 30 can be a matter of design choice. For example, in some embodiments, image clusters 48 can comprise a 32-by-32 array of image pixels 42 in digital image 40 corresponding to a two-by-two array of display clusters 30 each comprising a sixteen-by-sixteen array of display pixels 20, a four-by-four array of display clusters 30 each comprising an eight-by-eight array of display pixels 20, or an eight-by-eight array of display clusters 30 each comprising a four-by-four array of display pixels 20. Corresponding image and display pixels 42, 20 and corresponding image and display clusters 48, 30 are shown with lines 44 and 46, respectively, as in FIG. 3. Image and display clusters 48, 30 can be, but are not necessarily, square.

In embodiments, a display controller 18 can be operable to independently calculate, compute, or select a color palette 26 of different pixel colors 24 for each display cluster 30 derived exclusively from pixel colors 24 of mutually exclusive image clusters 48 of image pixels 42 corresponding to display pixels 20 of corresponding display clusters 30. By using only image pixels 42 in image clusters 48 to independently generate color palettes 26 for each display cluster 30, the displayed image on color display 10 corresponding to digital image 40 has improved color accuracy and image fidelity as a greater number of color palettes 26 (e.g., one per display cluster 30 and image cluster 48) can be used over smaller areas (e.g., clusters). Because embodiments of the present disclosure can use micro-transfer-printed cluster controllers 32 in each display cluster 30, cluster controllers 32 can have sufficiently large storage and complex cluster control circuits 38 to separately apply different color palettes 26. In embodiments prior-art displays using thin-film circuits cannot provide the same storage and processing capabilities to enable color palettes 26 for each display cluster 30 whereas embodiments of the present disclosure can micro-transfer-printed cluster controllers 32 comprising crystalline semiconductor integrated circuits with greater circuit density and performance.

In some embodiments, pixel colors 24 of color palette 26 are selected from pixel colors 24 of image pixels 42 in image cluster 48 corresponding to a display cluster 30, e.g., one or more of or all of pixel colors 24 in color palette 26 are equal to a pixel color 24 of image pixels 42 in image cluster 48 corresponding to display pixels 20 of display cluster 30. In some embodiments, pixel colors 24 in color palette 26 are not equal to any pixel color 24 of image pixels 42 in image cluster 48. In some embodiments, one or more of or all of pixel colors 24 in color palette 26 are a combination (e.g., an average or a weighted average) of two-or-more pixel colors 24 of image pixels 42 in image cluster 48 corresponding to display pixels 20 of display cluster 30.

Display controller 18 can also be operable to transmit color palette 26 to cluster controller 32 with a display-pixel value 22 for each display pixel 20 in display cluster 30 referencing a pixel color 24 in color palette 26. Thus, in a digital binary system in which each pixel color 24 in color palette 26 is referenced by a display-pixel value 22, for example as an address in a color palette 26 table or memory, display-pixel values 22 will have a number of bits equal to log2 of the number of pixel colors 24 in color palette 26. In embodiments, display-pixel value 22 can reference a pixel color 24 in color palette 26 that is closest to a pixel color 24 of an image pixel 42 corresponding to display pixel 20 in display cluster 30.

Corresponding to operations of display controller 18, each cluster controller 32 can be operable to receive color palette 26 and display-pixel values 22 from display controller 18. Each cluster controller 32 can then control each display pixel 20 in display cluster 30 to emit light specified by, responsive to, modifying, or incorporating pixel color 24 in color palette 26 referenced by display-pixel value 22. In some embodiments, cluster controller 32 controls each display pixel 20 to emit light specified by and equal to a pixel color 24 in color palette 26 referenced by display-pixel value 22. In some embodiments, cluster controller 32 controls each display pixel 20 to emit light derived from a pixel color 24 in color palette 26 referenced by display-pixel value 22. In some embodiments, cluster controller 32 each display pixel 20 emit light derived from a sum of a stored pixel color 24 associated with a display pixel 20 and a color pixel correction value (e.g., stored in color palette 26) referenced by display-pixel value 22.

A color palette 26 for an image cluster 48 can be a selection or representation of pixel colors 24 of image pixels 42 in image cluster 48. For each display cluster 30, a number of pixel colors 24 in color palette 26 can be smaller than a number of display pixels 20 in the display cluster 30, so that the amount of data transmitted to each display cluster 30 is smaller than the amount of data specifying pixel colors 24 of image pixels 42 in image cluster 48. This reduction in data reduces the amount of information transmitted to display clusters 30 of color display 10 and the required bandwidth, enabling color displays 10 using less expensive circuits or construction or having a greater number of display pixels 20 or increased frame rates, thus reducing costs or improving a bandwidth performance of color display 10.

Color palette 26 specifies one-or-more pixel colors 24 for each image cluster 48 but fewer than a pixel color 24 for each image pixel 42 in image cluster 48. Therefore, display controller 18 must select or generate pixel colors 24 of color palette 26 to represent or approximate pixel colors 24 of image pixels 42 for each image cluster 48, for example by analyzing a distribution of pixel colors 24 of image pixels 42 exclusively in image cluster 48, and then selecting a subset of pixel colors 24 or generating a set of pixel colors 24 for color palette 26. Any of a variety of methods or algorithms can be used to generate or select pixel colors 24 for color palette 26 and embodiments of the present disclosure are not limited by the selection or generation methods or algorithms. For example, k-means clustering can be used. K-means clustering is a method of vector quantization that can partition a set of values (e.g., pixel colors 24 of image pixels 42 in image cluster 48) into a set of clusters (e.g., pixel colors 24 in color palette 26) in which each value (e.g., display-pixel value 22) is assigned to one (e.g., a pixel color 24) of the set of clusters (e.g., color palette 26) having a mean closest to the value. Using such a method can assign each pixel color 24 of image pixels 42 in image cluster 48 to one of a set of pixel colors 24 in color palette 26 with display-pixel value 22, thus reducing the number of pixel colors 24 by a ratio (e.g., a data compression ratio) of the number of image pixels 42 in image cluster 48 to the number of pixel colors 24 in color palette 26.

The number of pixel colors 24 in color palette 26 is a design choice as is the image cluster 48 size. The larger the number of pixel colors 24 in color palette 26, the more accurately color palette 26 can represent image pixels 42 but the lower the compression ratio. Conversely, the smaller the number of pixel colors 24 in color palette 26, the less accurately color palette 26 can represent image pixels 42 but the greater the compression ratio. Similarly, a larger image cluster 48 size will have greater compression than a smaller image cluster 48 size.

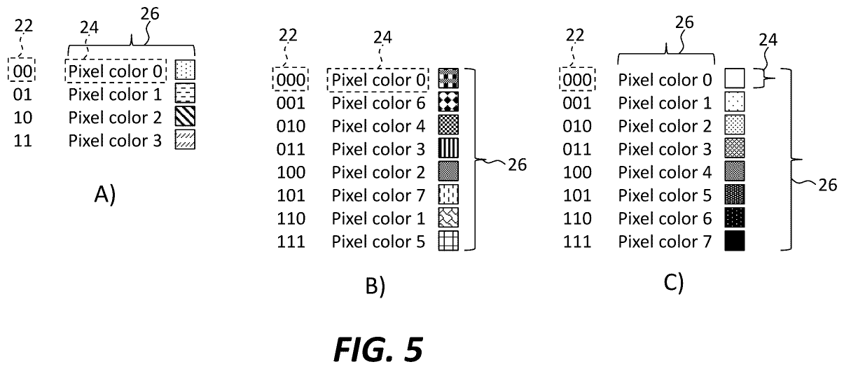

FIG. 5 illustrates pixel color palettes 26 comprising one-or-more pixel colors 24. A pixel color 24 is a value (e.g., a digital binary value) that specifies a color of light that can be output by display pixels 20 under the control of cluster controller 32. A display pixel 20 can comprise one or more light controllers (e.g., micro-iLEDs) 60 that each control or emit light of a specific color, for example red, green, and blue. Each light controller 60 can emit light with one or more luminances; the combination of luminances for each color of light emitted by light controllers 60 specifies pixel color 24. For example, each display pixel 20 can comprise a red micro-light-emitting diode that emits red light when provided with suitable electrical current at a desired voltage by display pixel 20 or cluster controller 32, each display pixel 20 can comprise a green micro-light-emitting diode that emits green light when provided with suitable electrical current at a desired voltage by display pixel 20 or cluster controller 32, and each display pixel 20 can comprise a blue micro-light-emitting diode that emits blue light when provided with suitable electrical current at a desired voltage by display pixel 20 or cluster controller 32. The number of luminance levels depends on the control circuits driving the micro-light-emitting diodes, for example 256 luminance levels (specified by eight bits) or 4096 luminance levels (specified by twelve bits). An eight-bit luminance-level with three light controllers 60 embodiment can therefor provide 2²⁴ different pixel colors 24 (16,777,216 different pixel colors 24).

FIG. 5 arbitrarily illustrates each pixel color 24 as a different pattern-filled square with a numeric label (“pixel color 0”. . . ). The collection of pixel colors 24 comprise color palette 26. Each pixel color 24 in color palette 26 is arbitrarily referenced by a display-pixel value 22, e.g., a binary value. Pixel colors 24 of color palette 26 can be stored as a table in a memory and each pixel color 24 in the table can be referenced as a table index value by display-pixel value 22 as shown.

As shown in the leftmost table A) of FIG. 5, color palette 26 comprises four pixel colors 24 stored in a table as pixel colors 24 0, 1, 2, 3 referenced by corresponding two-bit binary display-pixel values 22 00, 01, 10, and 11. The center and right tables B) and C) of FIG. 5 illustrate a color palette 26 comprising eight pixel colors 24 stored in a table as pixel colors 24 0, 1, 2, 3, 4, 5, 6, 7 referenced by corresponding three-bit binary display-pixel values 22 000, 001, 010, 011, 100, 101, 110, and 111. The association of pixel colors 24 with display-pixel values 22 is completely arbitrary as shown by the different labels in tables B) and C) of FIG. 5. The pixel colors 24 in the table can be ordered, for example by color or luminance as in C), but need not be ordered, as in B) and the arrangement of pixel colors 24 in color palette 26 is arbitrary (but must correspond to display-pixel values 22).

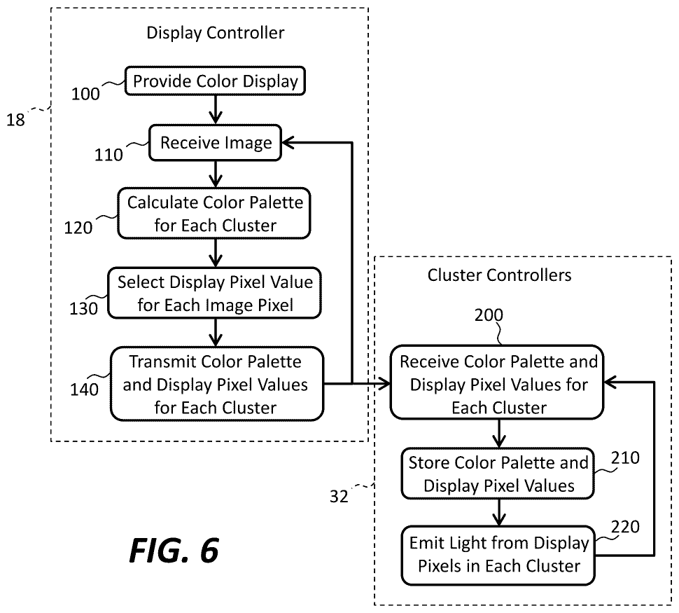

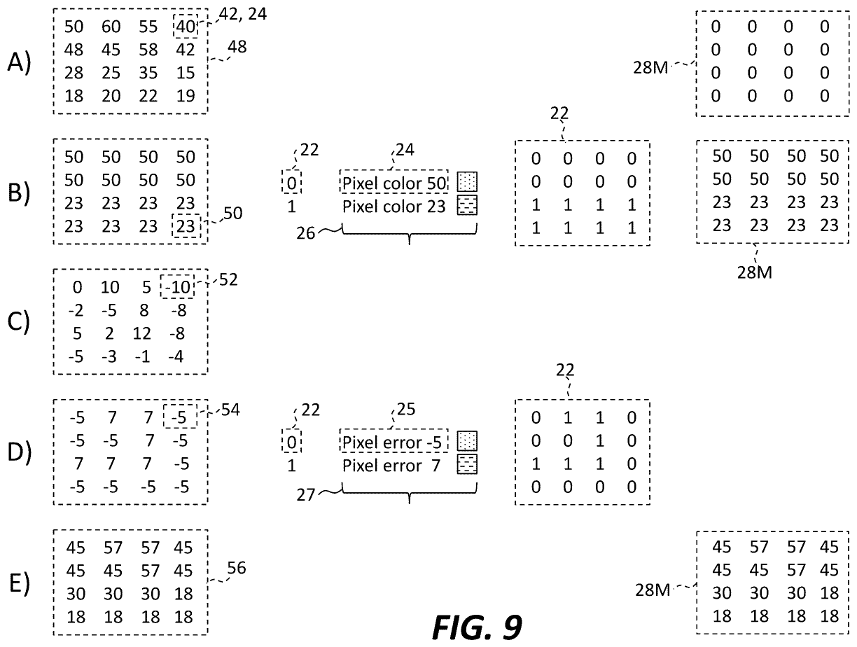

FIGS. 6-8 are flow diagrams and FIG. 9 is a worked example of methods according to embodiments of the present disclosure. As shown in FIG. 6, in step 100 a color display 10 having cluster controllers 32 controlling display clusters 30 of display pixels 20 responsive to display controller 18 is provided. In step 110, display controller 18 can receive digital image 40 comprising image pixels 42 forming an image. In embodiments, image pixels 42 of digital image 40 each correspond to a display pixel 20 in color display 10 so that digital image 40 can be displayed on color display 10 with pixel colors 24 (e.g., pixels) located in a same relative location in digital image 40 as in color display 10. In step 120, display controller 18 can process image clusters 48 of image pixels 42 in digital image 40 to calculate a color palette 26 of pixel colors 24. Pixel colors 24 of color palette 26 for each image cluster 48 can be independently calculated using only image pixels 42 in image cluster 48 so that each color palette 26 of each image cluster 48 is independent of color palettes 26 of other image clusters 48. In step 130, a display-pixel value 22 can be selected by display controller 18 for each display pixel 20 (corresponding to an image pixel 42) that references a pixel color 24 in each display cluster 30 (corresponding to an image cluster 48). Display controller 18 can then transmit color palette 26 and display-pixel values 22 for each image cluster 48 to a corresponding display cluster 30 cluster controller 32, for example using matrix addressing, in step 140.

FIG. 9 illustrates the image processing calculations for an image cluster 48. As shown in FIG. 9, table A is an arbitrarily selected four-by-four array of image pixels 42 (numbers) forming image cluster 48 received in step 110. Image pixels 42 of image cluster 48 roughly illustrate a horizontal edge between a darker (lower half) and lighter (upper half) image cluster 48 area, where a smaller number indicates a darker image pixel 42. Image pixels 42 in image cluster 48 are analyzed by display controller 18 in step 120 to determine two (in this example) representative quantized pixel colors 50 for image cluster 48, equal to fifty and twenty-three, as shown in table B. In step 130, a display-pixel value 22 is then selected by display controller 18 for each image pixel 42. For example, display-pixel value 22 can reference pixel color 24 in color palette 26 closest to (has a smallest difference from) image pixel 42, as shown in the array of display-pixel values 22 in table B. Each of display-pixel values 22 in the table physically corresponds to a display pixel 20 (e.g., a light controller 60 in display pixel 20). The correspondence is illustrated in FIG. 9 by presenting display-pixel values 22 in an array that corresponds to an array of display pixels 20 on display substrate 12 in display cluster 30 and corresponds to the array of image pixels 42, e.g., as shown in FIG. 3. Color palette 26 comprising two pixel colors 24 (e.g., fifty and twenty-three) and sixteen display-pixel values 22 (each of one bit to select between the two pixel colors 24 in color palette 26) are transmitted in step 140. In this example and assuming pixel colors 24 of eight bits, a conventional transmission of a pixel color 24 for each display pixel 20 in display cluster 30 would require sixteen times eight bits or 128 bits for each display cluster 30. In contrast and according to embodiments of the present disclosure, only two pixel colors 24 (for a total of sixteen bits) and a single bit for each display-pixel value 22 for sixteen display pixels 20 in display cluster 30, equaling 32 bits, are transmitted, for a reduction in transmitted data of a factor of four.

As shown in FIG. 6, each cluster controller 32 can receive a color palette 26 and display-pixel values 22 transmitted from display controller 18, in step 200. As those familiar with digital logic design will understand, a variety of circuit designs can output pixel colors 24 to display pixels 20. In the embodiment illustrated in FIGS. 2A and 2B, cluster control circuit 38 of cluster controller 32 receives color palette 26 and display-pixel values 22 and stores them in color-palette memory 26M and display-pixel-value memory 22M, respectively, in step 210. Cluster controller 32 can write pixel colors 24 in color palette 26 referenced by display-pixel values 22 into display-pixel-color memory 28M. Pixel colors 24 in display-pixel-color memory 28M can be output through drivers 36 to emit light from display pixels 20 in step 220.

Color-palette memory 26M must have enough memory to store all of the bits for each pixel color 24 in color palette 26, in this example sixteen (eight times two) bits. Display-pixel-value memory 22M must have enough memory to store all of the bits for each display-pixel value 22 in display cluster 30, in this example sixteen (four times four times one) bits. Display-pixel-color memory 28M must have enough memory to store a pixel color 24 for each display pixel 20, in this case eight bits for each of sixteen display pixels 20, or 128 bits. Display-pixel-color memory 28M can output (for example in parallel) a pixel color 24 for each display pixel 20 in a row of display pixels 20 in display cluster 30 (in this example four pixel colors 24) to support matrix-address control of display cluster 30. In embodiments, pixel colors 24 can be output serially from display-pixel-color memory 28M for pulse-width modulation control of display pixels 20 (and light controllers 60) to emit light from display pixels 20 in display cluster 30 in step 220.

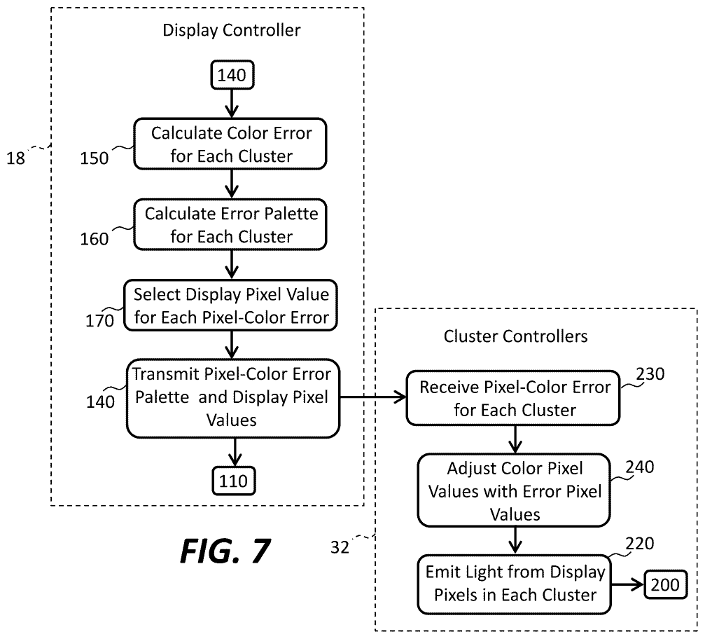

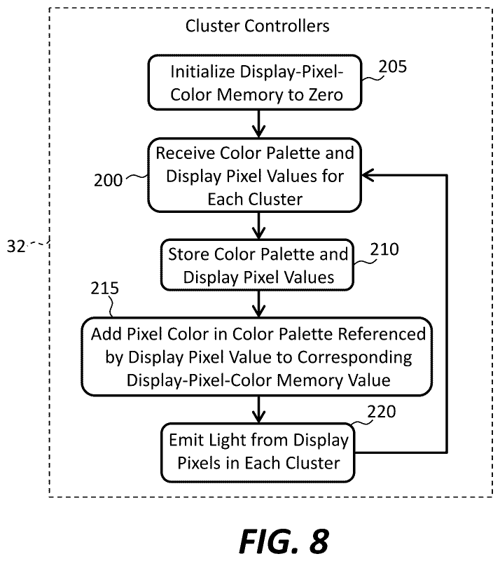

In some embodiments, pixel colors 24 in color palette 26 referenced by display-pixel values 22 are written into display-pixel-color memory 28M, as shown in the righthand column of B. In some embodiments, display-pixel-color memory 28M is first cleared (in step 205 of FIG. 8) and then corresponding pixel colors 24 in color palette 26 referenced by display-pixel values 22 are added to the contents of display-pixel-value memory 22M, also shown in the right-side column of table B. Using addition can support pixel color 24 correction for display pixels 20, as shown in FIG. 7 and tables C, D, and E of FIG. 9.

In embodiments of the present disclosure a pixel-color error 52 for display pixels 20 can be reduced by iteratively correcting color pixels 24 in display-pixel-color memory 28M. As shown in table C of FIG. 9, a pixel-color error 52 for each pixel color 24 of display pixel 20 can be calculated by taking a difference between the input image pixels 42 of table A and the displayed pixel colors 24 of display pixels 20 (e.g., as shown in table B) in the left and right columns where C=A−B). In embodiments, a variety of mathematical techniques can be used to calculate pixel-color errors 52 and corresponding corrections between the original image clusters 48 in digital image 40 and display-pixel clusters 30 in the displayed image on color display 10. Pixel-color error 52 can be quantized as was digital image 40 (table D) and used to correct pixel colors 24 of display pixels 20 (table E) equal to C+D) by repeating the quantization, reference, transmission and addition steps used to display the original pixel colors 24 of each display cluster 30.

As illustrated in FIG. 7, after the original color palette 26 and display-pixel values 22 for each image cluster 48 are transmitted to cluster controller 32 of each display cluster 30, display controller 18 can calculate a pixel-color error 52 for each image pixel 42 in each image cluster 48 in step 150, as shown in table C of FIG. 9. Pixel-color error 52 for each image pixel 42 in each image cluster 48 can be quantized to form quantized pixel-color errors 54 and a color correction color palette 26 can be generated in step 160 using the quantized pixel-color errors 54, for example with display controller 18, and as shown in table D) of FIG. 9. In this example, the quantized pixel-color errors 54 are −5 and 7 and display-pixel values 22 are as shown in the third column. The two quantized pixel-color errors 54 form a pixel-color-error palette 27 comprising pixel-color errors 52. As in step 130, display-pixel values 22 referencing quantized pixel-color errors 54 are selected in step 170, for example each quantized pixel-color error 54 referencing the closest pixel-color error 52 in an array of display-pixel values 22. The pixel-color-error palette 27 and the corresponding display-pixel values 22 can be transmitted to each display cluster 30 in step 140. Note that pixel-color-error palette 27 and display-pixel values 22, although specifying different information, are otherwise identical to the original color palette 26 and display-pixel values 22, so the same hardware or control circuits can be used for the error correction process as for the original pixel display process as shown in FIG. 6.

Similarly, and as shown in FIG. 7, cluster controllers 32 can receive the pixel-color-error palette 27 and display-pixel values 22 referencing the quantized pixel-color error 54 in color palette 26 in step 230. The pixel-color errors 52 in color palette 26 referenced by display-pixel values 22 can be added to pixel colors 24 stored in display-pixel-color memory 28M to correct the pixel colors 24 forming a corrected display image 56 and make pixel colors 24 closer to (more accurately represent) the original image pixels 42, as shown in table E) of FIG. 9, in step 240 and the pixel colors 24 emitted in step 220, as before. Note that, as with the color palette 26 for pixel-color errors 52 in display controller 18, this pixel color 24 error correction process can be identical to the original process (shown in FIG. 6), so that no additional hardware or control circuits need be included in cluster controller 32 to provide color correction to quantized pixel colors 50 in each display cluster 30.

The additive color-correction process is shown in more detail in FIG. 8. As shown in FIG. 8, display-pixel-color memory 28M is first cleared in step 205 (and shown in table A righthand side) of FIG. 9). After color palette 26 and display-pixel value 22 references are received by cluster controller 32 in step 200, they can be stored in step 210 (as in FIG. 6). Pixel colors 24 in color palette 26 referenced by display-pixel values 22 are added to pixel colors 24 in display-pixel-color memory 28M (e.g., under the control of cluster control circuit 38) in step 215 and light corresponding to pixel colors 24 in display-pixel-color memory 28M is emitted in step 220. This process, when applied to digital image 40 image pixels 42, corresponds to the process of FIG. 6. When applied to pixel-color errors 25 of pixel-color-error palette 27, the process corresponds to the process of FIG. 7. Cluster controllers 32 need not distinguish between image pixel 42 output (FIG. 6) and correction (FIG. 7), simplifying the hardware and cluster control circuits 38 of cluster controllers 32.

The corrected pixel colors 24 in display-pixel-color memory 28M output to display pixels 20 are closer to the original digital image 40 image pixels 42. An average or standard deviation difference between digital image 40 image pixels 42 in image cluster 48 (table A) and uncorrected displayed display pixels 20 (table C) can be −0.25 and 6.68, respectively. The same average or standard deviation difference between digital image 40 image pixels 42 in image cluster 48 (table A) and displayed display pixels 20 after correction (difference between tables A and E) can be 0.044 and 3.31, respectively. The process can be repeated to further improve the accuracy of pixel colors 24 in display clusters 30. A second round of correction can further reduce the values to −0.021 and 1.67, respectively. In embodiments of color display 10 in which a lower digital image 40 frame rate is acceptable, a higher display frame rate with color correction for sequential images displayed on color display 10 can provide improved pixel color 24 fidelity with reduced data transmission requirements.

If a new image frame is received for display, the display-pixel-color memory 28M must either be reset to zero as in step 205 (if using the process of FIG. 8) or the initial quantized color display steps (as in FIG. 6) must be performed, and any subsequent color error correction can use the method of FIG. 7. Thus, cluster controller 32 can have slightly different process steps for the initial display and the color correction. Either an initial clear step (step 205) must be performed with pixel color 24 addition (step 215) for both the initial display and the pixel color 24 correction when a new image frame is received, or the initial display must load pixel colors 24 into display-pixel-color memory 28M (step 210) and the color correction adds pixel-color errors 52 to pixel colors 24 in display-pixel-color memory 28M (step 240).

Because each display cluster 30 outputs color quantized image pixel 42 values (quantized pixel colors 50) independently derived independently from image pixel 42 each image cluster 48 and display cluster 30, each color palette 26 for each image cluster 48 is independent of every other color palette 26 for every other image cluster 48 so that the color palette 26 for one display cluster 30 can be different from a color palette 26 in at least one or all different display clusters 30.

In some embodiments and as shown in FIG. 3, an image number of image pixels 42 in an image cluster 48 is equal to a display number of display pixels 20 in a display cluster 30 so that the number of image pixels 42 of an image cluster 48 is the same as the number of display pixels 20 of a display cluster 30 (e.g., the size of an image cluster 48 is the same as the size of a display cluster 30). In some embodiments and as shown in FIG. 4, an image cluster 48 corresponds to multiple display clusters 30 so that image pixels 42 that are part of a common image cluster 48 can correspond to display pixels 20 in different display clusters 30. Thus, in some embodiments an image number of image pixels 42 in an image cluster 48 is greater than a display number of display pixels 20 in a display cluster 30. For example, the display number can evenly divide the image number by the number of display clusters 30.

In some such embodiments, a color palette 26 for an image cluster 48 can be sent to each display cluster 30 having display pixels 20 corresponding to image pixels 42 in the common image cluster 48 so that a single color palette 26 can be sent to multiple (e.g., four as shown in FIG. 4) cluster controllers 32 of display clusters 30 at a same time, further reducing the data bandwidth requirements for color display 10. In some such embodiments, the number of image pixels 42 in an image cluster 48 (e.g., an image number) can be greater than the number of display pixels 20 in a display cluster 30 (e.g., a display number), e.g., by a factor equal to the number of display clusters 30 corresponding to an image cluster 48.

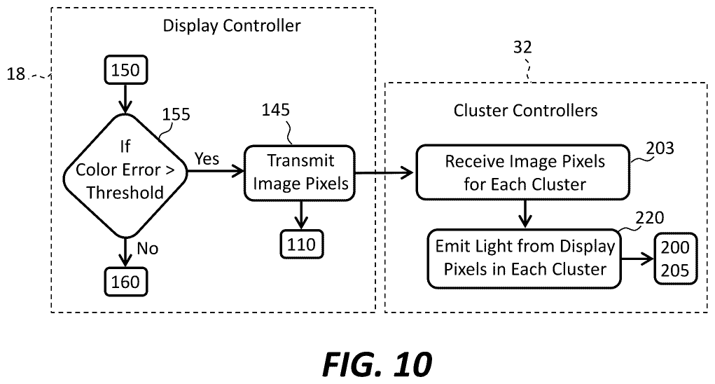

In some embodiments of the present disclosure, if quantized pixel-color error 54 in a display cluster 30 exceeds a color-error threshold, the actual image pixels 42 can be transmitted from display controller 18 to cluster controller 32 of display cluster 30. By sending actual image pixels 42 of an image cluster 48 to a corresponding display cluster 30, pixel-color error 52 is removed (e.g., set to zero). In some embodiments, therefore, and as illustrated in FIG. 10 display controller 18 is operable to compare quantized pixel-color error 54 to a color-error threshold in step 155 for each image cluster 48 after the color error is calculated in step 160 or step 120. If pixel-color error 52 for each image cluster 48 is less than the color-error threshold, the process proceeds as described in FIGS. 6-8. If pixel-color error 52 for each image cluster 48 is equal to or greater than the color-error threshold, display controller 18 is operable to transmit image pixels 42 for image cluster 48 to the corresponding display cluster(s) 30.

Cluster controllers 32 of display clusters 30 are operable to receive image pixels 42 of corresponding image cluster 48 from display controller 18 in step 203 and emit light corresponding to each image pixel 42 of display cluster 30. For example, image pixels 42 can be stored in display-pixel-color memory 28M under the control of cluster controller 32 and output in step 220 as described above. The process can then begin again with a new digital image 40 received by display controller 18. Since it is unlikely that pixel-color error 52 of every image cluster 48 will exceed the color-error threshold, such embodiments can improve color fidelity in the display image of color display 10 and still reduce the bandwidth requirements for color display 10.

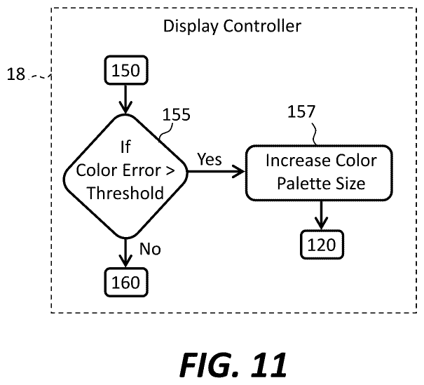

As shown in FIG. 11 and in some embodiments of the present disclosure, rather than sending the original image pixels 42 of an image cluster 48 to a corresponding display cluster 30 if the pixel-color error 52 exceed the color-error threshold, display controller 18 can be operable to select a larger color palette 26 (e.g., comprising an increased number of pixel colors 24, for example twice as many) in step 157. The process can then proceed as described in FIGS. 6-8. By using more pixel colors 24 in color palette 26, color fidelity in the display image can be improved and bandwidth requirements of color display 10 reduced, improving frame rate or reducing costs, or both.

Thus, in embodiments of the present disclosure, color display 10 is adaptive and can modify its operation in response to different digital images 40 and sizes of color palettes 26.

Having described certain implementations of embodiments, it will now become apparent to one of skill in the art that other implementations incorporating the concepts of the disclosure may be used. Therefore, the disclosure should not be limited to certain implementations but rather should be limited only by the spirit and scope of the following claims.

Throughout the description, where apparatus and systems are described as having, including, or comprising specific elements, or where processes and methods are described as having, including, or comprising specific steps, it is contemplated that, additionally, there are apparatus and systems of the disclosed technology that consist essentially of, or consist of, the recited elements, and that there are processes and methods according to the disclosed technology that consist essentially of, or consist of, the recited processing steps.

It should be understood that the order of steps or order for performing certain action is immaterial so long as operability is maintained. Moreover, two or more steps or actions in some circumstances can be conducted simultaneously. The disclosure has been described in detail with particular reference to certain embodiments thereof, but it will be understood that variations and modifications can be effected within the spirit and scope of the disclosure.

### PARTS LIST

H horizontal direction/X direction
V vertical direction/Y direction
10 color display
12 display substrate
14 display area
16R display row wire
16C display column wire
18 display controller
18A display control circuit
18C display column controller
18R display row controller
20 display pixel
22 display-pixel value
22M display-pixel-value memory
24 pixel color
26 color palette
26M color-palette memory
27 pixel-color-error palette
28M display-pixel-color memory
30 display cluster/display-pixel cluster
32 cluster controller
34C cluster column wire
34R cluster row wire
36 driver
38 cluster control circuit
40 digital image
42 image pixel
44 line
46 line
48 image cluster/image pixel cluster
50 quantized pixel color
52 pixel-color error
54 quantized pixel-color error
56 corrected display image
60 micro-light-emitting diode (iLED)/light controller
60B blue iLED
60G green iLED
60R red iLED
70 tether
100 provide color display step
110 receive image step
120 calculate color palette for each cluster step
130 select display-pixel value for each image pixel step
140 transmit color palette and display-pixel values step
145 transmit image pixels step
150 calculate color error for each cluster step
155 if color error exceeds threshold step
157 increase color palette size step
160 calculate error palette for each cluster step
170 transmit error pixel values for each cluster step
200 receive color palette and display-pixel values step
203 image pixels step
205 initialize display-pixel-color memory to zero step
210 store color palette and display-pixel values step
215 add pixel color in color palette referenced by display-pixel value to corresponding display pixel-color-memory value step
220 emit light from display pixels step
230 receive error pixel values for each cluster step
240 adjust pixel color values with error pixel values step

What is claimed:

1. A color display, comprising:
an array of display pixels comprising mutually exclusive display clusters of display pixels, each display pixel operable to emit light of different colors responsive to a display-pixel value and pixel color;
a cluster controller operable to control the display pixels in each display cluster of display pixels to emit light of different colors; and
a display controller operable to (i) calculate a color palette of different pixel colors for each display cluster derived exclusively from pixel colors of mutually exclusive image clusters of image pixels in a digital image, each image pixel corresponding to a display pixel, and (ii) transmit the color palette to the cluster controller with a display-pixel value for each display pixel in the display cluster referencing a pixel color in the color palette,
wherein each cluster controller is operable to (i) receive the color palette and display-pixel values from the display controller and (ii) control each display pixel in the display cluster to emit light responsive to the pixel color in the color palette referenced by the display-pixel value, and
wherein for each display cluster, a number of pixel colors in the color palette is smaller than a number of display pixels in the display cluster.

2. The color display of claim 1, wherein (i) each display cluster comprises display pixels that are locally adjacent, (ii) each image cluster comprises image pixels that are locally adjacent, or (iii) both.

3. The color display of claim 1, wherein the display-pixel value has a number of bits equal to log2 of the number of colors in the color palette.

4. The color display of claim 1, wherein one or more pixel colors in the color palette of a display cluster are pixel color(s) of one or more of the image pixels corresponding to display pixels in the display cluster.

5. The color display of claim 1, wherein one or more colors in the color palette of a display cluster are a combination of colors of two or more of the image pixels corresponding to display pixels in the display cluster.

6. The color display of claim 1, wherein each display-pixel value in a display cluster references a pixel color in the color palette that is closest to a pixel color of an image pixel corresponding to the display pixel in the display cluster.

7. The color display of claim 1, wherein the color display has a display area including the display pixels and the cluster controller of one or more display clusters is disposed within the display area, between two or more display pixels in the display area, or both.

8. The color display of claim 1, wherein the cluster controller is connected to each display pixel in the display cluster and provides passive-matrix or active-matrix control to the display pixels.

9. The color display of claim 1, wherein the cluster controller is a micro-transfer-printed integrated circuit comprising a fractured or separated tether.

10. The color display of claim 1, wherein each display pixel comprises two or more light emitters that emit different colors of light.

11. The color display of claim 10, wherein the two or more light emitters are micro-transfer-printed micro-light-emitting diodes comprising a fractured or separated tether.

12. The color display of claim 1, wherein each cluster controller comprises one or more of (i) a color-palette memory operable to store the color palette, (ii) a display-pixel-value memory operable to store display-pixel values, and (iii) a display-pixel-color memory operable to store pixel colors.

13. The color display of claim 1, wherein (i) the cluster controller is operable to add received error-correcting pixel colors to stored pixel colors or (ii) the cluster controller is operable to add received pixel colors to stored zero values.

14. The color display of claim 1, wherein the color palette for one display cluster is different from a color palette in at least one different display cluster.

15. The color display of claim 1, wherein the display controller is operable to send the same color palette to multiple cluster controllers.

16. The color display of claim 1, wherein an image cluster includes an image number of image pixels, a display cluster includes a display number of display pixels equal to the image number, and the display pixels correspond to the image pixels.

17. The color display of claim 1, wherein an image cluster includes an image number of image pixels and a display cluster includes a display number of display pixels less than the image number, and the display pixels correspond to a subset of the image pixels.

18. The color display of claim 17, wherein at least one image cluster corresponds to multiple display clusters, so that the image pixels of the at least one image cluster corresponds to the display pixels of multiple display clusters.

19. The color display of claim 1, wherein the display controller is operable to calculate a pixel-color error for each image cluster responsive to image pixels in the image cluster and corresponding pixel colors in the color palette referenced by the display-pixel values.

20. The color display of claim 19, wherein the display controller is operable to compare the pixel-color error for each image cluster to a color-error threshold and, if the pixel-color error is greater than or equal to the color-error threshold, (i) transmit image pixels to the corresponding display cluster and the cluster controller is operable to receive and display the image pixels or (ii) select a larger color palette and transmit the pixel colors of the larger color palette to the corresponding display cluster and the cluster controller is operable to receive and display the pixel colors of the larger color palette.

21. A method of operating a color display comprising display clusters of mutually exclusive color display pixels, comprising:
receiving a digital image with a display controller, the digital image comprising image pixels, each image pixel defining a pixel color associated with a corresponding display pixel;
using the display controller, calculating a color palette for each display cluster derived exclusively from image pixels in the image corresponding to display pixels in the display cluster, the color palette having fewer colors than display pixels in the display cluster;
using the display controller, transmitting (i) the color palette and (ii) a display-pixel value that references one of the colors in the color palette for each display pixel in the display cluster to the cluster controller of the display cluster;
using each cluster controller of a display cluster, receiving a color palette and a display-pixel value referencing one of the colors in the color palette for each display pixel in the display cluster from the display controller; and
responsive to the color palette and the reference, emitting light from each display pixel in the display cluster with display pixels under the control of the cluster controller.

22. The method of claim 21, wherein the display-pixel values are first display-pixel values and further comprising:
with the display controller, transmitting a second display-pixel value referencing one of the colors in the color palette for each display pixel in the display cluster to the display cluster, wherein the second display-pixel value is a difference between the corresponding image pixel and the first display-pixel value;
with each cluster controller of a display cluster, receiving a second display-pixel value for each display pixel in the display cluster, and adding the color palette color referenced by the second display-pixel value to the color palette color referenced by the first display-pixel value to specify a corrected color; and
with each display pixel in the display cluster, emitting light corresponding to the corrected color under the control of the cluster controller.

23. The method of claim 21, wherein the display controller calculates a pixel-color error for each image cluster responsive to image pixels in the image cluster and corresponding pixel colors in the color palette referenced by the display-pixel values.

24. The color display of claim 23, wherein the display controller compares the pixel-color error for each image cluster to a color-error threshold and, if the pixel-color error is greater than or equal to the color-error threshold, (i) transmits image pixels to the corresponding display cluster and the cluster controller receives and displays the image pixels or (ii) selects a larger color palette and transmits the pixel colors of the larger color palette to the corresponding display cluster and the cluster controller receives and displays the pixel colors of the larger color palette.

25. A color-display cluster, comprising:
an array of display pixels, each display pixel operable to emit light of different colors responsive to a display-pixel value and pixel color;
a color palette comprising different pixel colors derived exclusively from pixel colors of mutually exclusive image clusters of image pixels in a digital image corresponding to the display pixels; and
a cluster controller operable to (i) control the display pixels to emit light of different pixel colors, (ii) receive a color palette and display-pixel values, and (iii) control each display pixel to emit light specified by the pixel color in the color palette referenced by the display-pixel value,
wherein the display-pixel value for each display pixel references a pixel color in the color palette, and
wherein for each display cluster, a number of pixel colors in the color palette is smaller than a number of display pixels in the display cluster.
